(19) United States
(12) Patent Application Publication
(10) Pub. No.: US 2023/0135243 A1
(43) Pub. Date: May 4, 2023

(54) TIRE WITH SPECIFIED CORD CONSTRUCTION

(71) Applicant: The Goodyear Tire & Rubber Company, Akron, OH (US)

(72) Inventor: Robert Edward Lionetti, Bereldange (LU)

(21) Appl. No.: 17/519,031

(22) Filed: Nov. 4, 2021

(51) Int. Cl. D07B 1/06; D07B 1/00

(52) U.S. Cl. CPC D07B 1/0613; D07B 1/005; D07B 1/062; D07B 2201/2006; D07B 2201/2061; D07B 2205/205; D07B 2205/2039; D07B 2205/3025; D07B 2201/1036; D07B 2201/2023; D07B 2501/2046

(57) ABSTRACT

A cord reinforces a rubber article. The cord includes a core strand having a two-layer twisted layer structure formed by intertwining a plurality of filaments, a plurality sheath strands intertwined around the core strand, the sheath strands having a twisted layer structure formed by intertwining a plurality of filaments, and a wrap wire applied around the core strand and at least one of the sheath strands. The wrap wire creating a permanent and stable minimum gap between the core strand and the sheath strands.

### FIELD OF THE INVENTION

The present invention relates to tires, and more particularly, to a heavy duty radial tire improving durability and resistance to tire damage based on exterior input such as cut burst, shock burst, or the like which may occur on rough roads exemplified by a non-paved road surface.

### BACKGROUND OF THE INVENTION

Conventionally, high-speed running and diversification of running mode progress has been achieved with improving performances of vehicles. Therefore, service conditions for tires used in these vehicles may be severe compared to conventional service conditions. Since durability in the tire is a particularly desirous characteristic, not only the occurrence of separation failure from a ply/belt cord end in a new tire, but also the occurrence of large cracks in the ply/belt cord ends of a used tire may diminish durability. Such durability may be particularly destructive to low-section profile tires used in low deck vehicles.

Operation on non-paved roads may further deteriorate durability. Although protuberant pebbles/stones and quarrying may be unavoidable on the non-paved road surfaces, foreign objects such as metallic pieces with sharp edges may be present on paved road surfaces. Therefore, when a tire mounted on a vehicle may roll over foreign matter, such as protuberant pebbles/stones, quarrying, metallic pieces and the like, thereby causing cut damage at a belt edge, burst failure anywhere, and/or shock burst prior to the cut damage.

Further, a heavy duty tire may advantageously have a sufficient resistance to cord separation in a new tire, improved durability of cord ends in used tires, and improved cut burst and shock burst resistance throughout. Such a heavy duty tire may thus demonstrate a prolonged total service life.

### SUMMARY OF THE INVENTION

A cord in accordance with the present invention reinforces a rubber article. The cord includes a core strand having a two-layer twisted layer structure formed by intertwining a plurality of filaments, a plurality sheath strands intertwined around the core strand, the sheath strands having a twisted layer structure formed by intertwining a plurality of filaments, and a wrap wire applied around the core strand and at least one of the sheath strands. The wrap wire creating a permanent and stable minimum gap between the core strand and the sheath strands.

According to another aspect of the cord, the plurality of sheath strands includes between 4 and 8 sheath strands.

According to still another aspect of the cord, the core strand has a 1+6 structure with the core of the core strand comprising one core filament and six sheath filaments being intertwined around the core of the core strand to form a sheath.

According to yet another aspect of the cord, each sheath strand has a 1+6 structure with a core of the sheath strand comprising one core filament and six sheath filaments being intertwined around the core of the sheath strand to form a sheath.

According to still another aspect of the cord, each filament forms the core strand has an identical diameter.

According to yet another aspect of the cord, a diameter of the cord is 4 mm or greater.

According to still another aspect of the cord, a diameter of the cord is less than 5 mm.

According to yet another aspect of the cord, the rubber article is a tire.

A tire in accordance with the present invention includes: two bead structures; a carcass extending from one bead structure to the other bead structure; a belt disposed radially outward from the carcass; a tread for engaging a road surface; and a cord including a core strand having a two-layer twisted layer structure formed by intertwining a plurality of filaments, a plurality sheath strands intertwined around the core strand, the sheath strands having a twisted layer structure formed by intertwining a plurality of filaments, and a wrap wire applied around the core strand and at least one of the sheath strands. The wrap wire creates a permanent and stable minimum gap between the core strand and the sheath strands.

According to another aspect of the tire, the plurality of sheath strands includes between 4 and 8 sheath strands.

According to still another aspect of the tire, the core strand has a 1+6 structure with the core of the core strand comprising one core filament and six sheath filaments being intertwined around the core of the core strand to form a sheath.

According to yet another aspect of the tire, each sheath strand has a 1+6 structure with a core of the sheath strand comprising one core filament and six sheath filaments being intertwined around the core of the sheath strand to form a sheath.

According to still another aspect of the tire, each filament forms the core strand has an identical diameter.

According to yet another aspect of the tire, a diameter of the cord is 4 mm or greater.

According to still another aspect of the tire, a diameter of the cord is less than 5 mm.

According to yet another aspect of the tire, the wrap wire in constructed of steel.

According to still another aspect of the tire, the wrap wire in constructed of a polymer.

According to yet another aspect of the tire, the wrap wire in constructed of nylon.

According to still another aspect of the tire, the wrap wire in constructed of polyester.

According to yet another aspect of the tire, the wrap wire in constructed of aramid.

### Definitions

As used herein and in the claims:

“Apex” means an elastomeric filler located radially above the bead core and between the plies and the turnup ply.

“Annular” means formed like a ring.

“Aramid” and “Aromatic polyamide” both mean a manufactured fiber in which the fiber-forming substance is generally recognized as a long chain of synthetic aromatic polyamide in which at least 85 percent of the amide linkages are attached directly to the two aromatic rings. Representative of an aramid or aromatic polyamide is a poly (p-phenyleneterephthalamide).

“Aspect ratio” means the ratio of a tire section height to its section width. For example, the aspect ratio may be the maximum axial distance between the exterior of the tire sidewalls when unloaded and inflated at normal pressure, multiplied by 100 percent for expression as a percentage. Low aspect ratio may mean a tire having an aspect ratio of 65 and below.

“Aspect ratio of a bead cross-section” means the ratio of a bead section height to its section width.

“Asymmetric tread” means a tread that has a tread pattern not symmetrical about the centerplane or equatorial plane (EP) of the tire.

“Axial” and “axially” refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane (EP) of the tire. The belt structure may also include plies of parallel cords inclined at relatively low angles, acting as restricting layers.

“Bias tire” (cross ply) means a tire in which the reinforcing cords in the carcass ply extend diagonally across the tire from bead to bead at about a 25° to 65° angle with respect to equatorial plane (EP) of the tire. If multiple plies are present, the ply cords run at opposite angles in alternating layers.

“Breakers” means at least two annular layers or plies of parallel reinforcement cords having the same angle with reference to the equatorial plane (EP) of the tire as the parallel reinforcing cords in carcass plies. Breakers are usually associated with bias tires.

“Cable” means a cord formed by twisting together two or more plied yarns.

“Carcass” means the tire structure apart from the belt structure, tread, undertread, and sidewall rubber over the plies, but including the beads.

“Casing” means the carcass, belt structure, beads, sidewalls, and all other components of the tire excepting the tread and undertread, i.e., the whole tire.

“Chipper” refers to a narrow band of fabric or steel cords located in the bead area whose function is to reinforce the bead area and stabilize the radially inwardmost part of the sidewall.

“Circumferential” and “circumferentially” mean lines or directions extending along the perimeter of the surface of the annular tire parallel to the equatorial plane (EP) and perpendicular to the axial direction; it can also refer to the direction of the sets of adjacent circular curves whose radii define the axial curvature of the tread, as viewed in cross section.

“Cord” means one of the reinforcement strands of which the reinforcement structures of the tire are comprised.

“Cord angle” means the acute angle, left or right in a plan view of the tire, formed by a cord with respect to the equatorial plane (EP). The “cord angle” is measured in a cured but uninflated tire.

“Cord twist” means each yarn of the cord has its component filaments twisted together a given number of turns per unit of length of the yarn (usually expressed in turns per inch (TPI) or turns per meter (TPM)) and additionally the yarns are twisted together a given number of turns per unit of length of the cord. The direction of twist refers to the direction of slope of the spirals of a yarn or cord when it is held vertically. If the slope of the spirals conforms in direction to the slope of the letter “S”, then the twist is called “S” or “left hand”. If the slope of the spirals conforms in direction to the slope of the letter “Z”, then the twist is called “Z” or “right hand”. An “S” or “left hand” twist direction is understood to be an opposite direction from a “Z” or “right hand” twist. “Yarn twist” is understood to mean the twist imparted to a yarn before the yarn is incorporated into a cord, and “cord twist” is understood to mean the twist imparted to two or more yarns when they are twisted together with one another to form a cord. “dtex” is understood to mean the weight in grams of 10,000 meters of a yarn before the yarn has a twist imparted thereto.

“Cut belt ply” refers to a belt having a width less than the tread width, which lies flat over the carcass plies in the crown area of the tire.

“Crown” means that portion of the tire in the proximity of the tire tread.

“Denier” means the weight in grams per 9000 meters (unit for expressing linear density).

“Dtex” means the weight in grams per 10,000 meters.

“Density” means weight per unit length.

“Elastomer” means a resilient material capable of recovering size and shape after deformation.

“Equatorial plane (EP)” means the plane perpendicular to the tire's axis of rotation and passing through the center of its tread; or the plane containing the circumferential centerline of the tread.

“Evolving tread pattern” means a tread pattern, the running surface of which, which is intended to be in contact with the road, evolves with the wear of the tread resulting from the travel of the tire against a road surface, the evolution being predetermined at the time of designing the tire, so as to obtain adhesion and road handling performances which remain substantially unchanged during the entire period of use/wear of the tire, no matter the degree of wear of the tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made, that forms the basic element of filaments; characterized by having a length at least 100 times its diameter or width.

“Filament count” means the number of filaments that make up a yarn. Example: 1000 denier polyester has approximately 190 filaments.

“Flipper” refers to a reinforcing fabric around the bead wire for strength and to tie the bead wire in the tire body.

“Footprint” means the contact patch or area of contact of the tire tread with a flat surface at zero speed and under normal load and pressure.

“Gauge” refers generally to a measurement, and specifically to a thickness measurement.

“Groove” means an elongated void area in a tread that may extend circumferentially or laterally about the tread in a straight, curved, or zigzag manner. Circumferentially and laterally extending grooves sometimes have common portions. The “groove width” may be the tread surface occupied by a groove or groove portion divided by the length of such groove or groove portion; thus, the groove width may be its average width over its length. Grooves may be of varying depths in a tire. The depth of a groove may vary around the circumference of the tread, or the depth of one groove may be constant but vary from the depth of another groove in the tire. If such narrow or wide grooves are of substantially reduced depth as compared to wide circumferential grooves, which they interconnect, they may be regarded as forming “tie bars” tending to maintain a rib-like character in the tread region involved. As used herein, a groove is intended to have a width large enough to remain open in the tires contact patch or footprint.

“High tensile steel (HT)” means a carbon steel with a tensile strength of at least 3400 MPa at 0.20 mm filament diameter.

“Inner” means toward the inside of the tire and “outer” means toward its exterior.

“Innerliner” means the layer or layers of elastomer or other material that form the inside surface of a tubeless tire and that contain the inflating fluid within the tire.

“Inboard side” means the side of the tire nearest the vehicle when the tire is mounted on a wheel and the wheel is mounted on the vehicle.

“LASE” is load at specified elongation.

“Lateral” means an axial direction.

“Lay length” means the distance at which a twisted filament or strand travels to make a 360° rotation about another filament or strand.

“Load range” means load and inflation limits for a given tire used in a specific type of service as defined by tables in The Tire and Rim Association, Inc.

“Mega tensile steel (MT)” means a carbon steel with a tensile strength of at least 4500 MPa at 0.20 mm filament diameter.

“Monofilament” means a single, generally large filament of synthetic fiber

“Net contact area” means the total area of ground contacting elements between defined boundary edges as measured around the entire circumference of the tread.

“Net-to-gross ratio” means the total area of ground contacting tread elements between lateral edges of the tread around the entire circumference of the tread divided by the gross area of the entire circumference of the tread between the lateral edges.

“Non-directional tread” means a tread that has no preferred direction of forward travel and is not required to be positioned on a vehicle in a specific wheel position or positions to ensure that the tread pattern is aligned with the preferred direction of travel. Conversely, a directional tread pattern has a preferred direction of travel requiring specific wheel positioning.

“Normal load” means the specific design inflation pressure and load assigned by the appropriate standards organization for the service condition for the tire.

“Normal tensile steel (NT)” means a carbon steel with a tensile strength of at least 2800 MPa at 0.20 mm filament diameter.

“Outboard side” means the side of the tire farthest away from the vehicle when the tire is mounted on a wheel and the wheel is mounted on the vehicle.

“Ply” means a cord-reinforced layer of rubber-coated radially deployed or otherwise parallel cords.

“Radial” and “radially” mean directions radially toward or away from the axis of rotation of the tire.

“Radial ply structure” means the one or more carcass plies or which at least one ply has reinforcing cords oriented at an angle of between 65° and 90° with respect to the equatorial plane (EP) of the tire.

“Radial ply tire” means a belted or circumferentially-restricted pneumatic tire in which at least one ply has cords which extend from bead to bead and the ply is laid at cord angles between 65° and 90° with respect to the equatorial plane (EP) of the tire.

“Rib” means a circumferentially extending strip of rubber on the tread which is defined by at least one circumferential groove and either a second such groove or a lateral edge, the strip being laterally undivided by full-depth grooves.

“Rivet” means an open space between cords in a layer.

“Section height” means the radial distance from the nominal rim diameter to the outer diameter of the tire at its equatorial plane (EP).

“Section width” means the maximum linear distance parallel to the axis of the tire and between the exterior of its sidewalls when and after it has been inflated at normal pressure for 24 hours, but unloaded, excluding elevations of the sidewalls due to labeling, decoration, or protective bands.

“Self-supporting run-flat” means a type of tire that has a structure wherein the tire structure alone is sufficiently strong to support the vehicle load when the tire is operated in the uninflated condition for limited periods of time and limited speed. The sidewall and internal surfaces of the tire may not collapse or buckle onto themselves due to the tire structure alone (e.g., no internal structures).

“Sidewall insert” means elastomer or cord reinforcements located in the sidewall region of a tire. The insert may be an addition to the carcass reinforcing ply and outer sidewall rubber that forms the outer surface of the tire.

“Sidewall” means that portion of a tire between the tread and the bead.

“Sipe” or “incision” means small slots molded into the tread elements of the tire that subdivide the tread surface and improve traction; sipes may be designed to close when within the contact patch or footprint, as distinguished from grooves.

“Spring rate” means the stiffness of tire expressed as the slope of the load deflection curve at a given pressure.

“Stiffness ratio” means the value of a control belt structure stiffness divided by the value of another belt structure stiffness when the values are determined by a fixed three point bending test having both ends of the cord supported and flexed by a load centered between the fixed ends.

“Super tensile steel (ST)” means a carbon steel with a tensile strength of at least 3650 MPa at 0.20 mm filament diameter.

“Tenacity” means stress expressed as force per unit linear density of the unstrained specimen (cN/tex).

“Tensile stress” is force expressed in force/cross-sectional area. Strength in psi=12,800 times specific gravity times tenacity in grams per denier.

“Tension” for a cord means force on the cord expressed as mN/tex.

“Toe guard” refers to the circumferentially deployed elastomeric rim-contacting portion of the tire axially inward of each bead.

“Tread” means a molded rubber component which, when bonded to a tire casing, includes that portion of the tire that comes into contact with the road when the tire is normally inflated and under normal load.

“Tread element” or “traction element” means a rib or a block element.

“Tread width” means the arc length of the tread surface in a plane including the axis of rotation of the tire.

“Turns per inch”, or TPI, means turns of cord twist for each inch length of cord.

“Turnup end” means the portion of a carcass ply that turns upward (i.e., radially outward) from the beads about which the ply is wrapped.

“Ultra tensile steel (UT)” means a carbon steel with a tensile strength of at least 4000 MPa at 0.20 mm filament diameter.

“Vertical deflection” means the amount that a tire deflects under load.

“Warp” means, in weaving/forming of fabric, lengthwise or longitudinal warp yarns, filaments, threads, cables, fibers, and/or cords may be held stationary in tension on a frame or loom while transverse “weft” yarns, filaments, threads, cables, fibers, and/or cords may be drawn through, and inserted over-and-under, the warp yarns, filaments, threads, fibers, and/or cords.

“Weft” means, in weaving/forming of fabric, transverse yarns, filaments, threads, cables, fibers, and/or cords may be drawn through, and inserted over-and-under, “warp” yarns, filaments, threads, cables, fibers, and/or cords. A single weft yarn, filament, thread, cable, fiber, and/or cord of a weft crossing the “warp” yarns, filaments, threads, cables, and/or cords may be termed a “pick”. Conventional weft yarns, filaments, threads, cables, fibers, and/or cords may only function to maintain the lateral spacing of the “warp” yarns, filaments, threads, cables, fibers, and/or cords during assembly and pre-installation handling.

“Yarn” is a generic term for a continuous strand of textile fibers or filaments. Yarn occurs in the following forms: (1) a number of fibers twisted together; (2) a number of filaments laid together without twist; (3) a number of filaments laid together with a degree of twist; (4) a single filament with or without twist (monofilament); and (5) a narrow strip of material with or without twist.

### BRIEF DESCRIPTION OF THE DRAWINGS

The present invention will be described with reference to the accompanying drawings, wherein:

FIG. 1 is a schematic cross-section view of an example tire for use with the present invention; and

FIG. 2 is a schematic cross-section view of a cord in accordance with the present invention.

### DESCRIPTION OF EXAMPLES OF THE PRESENT INVENTION

The following language is of the best presently contemplated example mode or modes for carrying out the present invention. This description is made for the purpose of illustrating the general principals of the present invention and should not be interpreted as a limitation of the appended claims. The scope of the present invention may be best determined by reference to the appended claims. As a supplement to the description below, U.S. Pat. Nos. 6,412,534 and 7,104,299 are hereby incorporated by reference in their entirety.

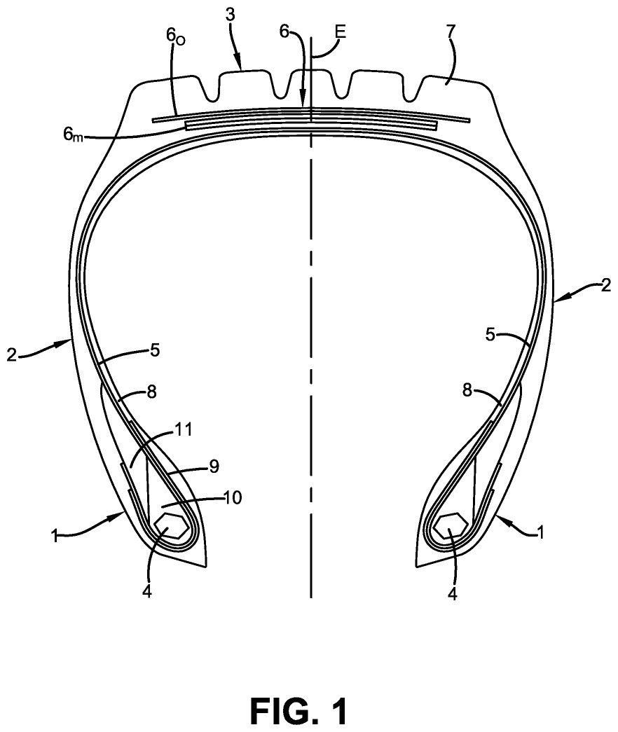

Referring to FIG. 1, a tire, pneumatic or non-pneumatic, for use with the present invention may include a pair of bead portions 1, a pair of sidewall portions 2, a tread portion 3 extending between each sidewall portion 2, a carcass 5 of one or more plies (one ply in FIG. 1) extending between a pair of bead cores 4 embedded in the bead portions 1 to reinforce the bead, sidewall, and tread portions 1, 2, 3, and a belt 6 reinforcing the tread portion 3 on the outer circumference of the carcass 5. The carcass 5 and belt 6 may include a rubberized ply of multiple cords 100. The belt 6 may include at least two rubberized steel wire element layers (3 shown in FIG. 1). Each cord 100 may be formed of a metal, such as steel, titanium, aluminum, etc., and/or organic fibers, such as an aromatic polyamide fiber, a nylon fiber, a polyester fiber, etc. and/or inorganic fibers, such as carbon fiber, etc., and/or any combination thereof.

A radially outermost belt layer (e.g., overlay, etc.) 60 of the belt 6 may be a layer(s) containing steel cords/wires or organic cords or inorganic cords 100 arranged between −5 degrees and +5 degrees with respect to an equatorial plane E of the tire. At least one other layer 6M (two layers in FIG. 1) may be located radially inward from the outermost belt layer 60. If steel, the cords 100 may constitute a skeleton of each of the layers 6_{O}, 6_{M} of the belt 6 defined by one or more bundles of one or more steel filaments without twisting, and/or one or more steel cords obtained by twisting plural steel filaments, and/or one or more steel monofilaments.

Multi strand cord reinforcements have been used to reinforce rubber in off the road tires in both plies 5 and belts 6. Conventional tires have used a resin to fill the gap(s) between the inner core strands and outer sheath strands of the multi strand cords 5 or 6 and to optimize the filament crossing angle between the outer sheath strands and the inner core strands. One conventional method has co-extruded a rubber or resin on the inner core strand during cable production. A more robust solution where the gap(s) may be better controlled would be desirable.

Durability of a tire may be extended if corrosion propagation can be limited. If an external object penetrates to a level of a carcass cord 5 or a belt cord 6, exposing it to oxidation from the service environment, particularly moisture, corrosion may propagate. Depth of rubber penetration may increase when the strands of the multi strand construction have gaps 140 therebetween thereby allowing more rubber to penetrate from and between the outer sheath 130 to the inner core 140 of the strand 100. Such increased rubber penetration may thus decrease exposure of the cords 5, 6 and decrease corrosion following external object penetration.

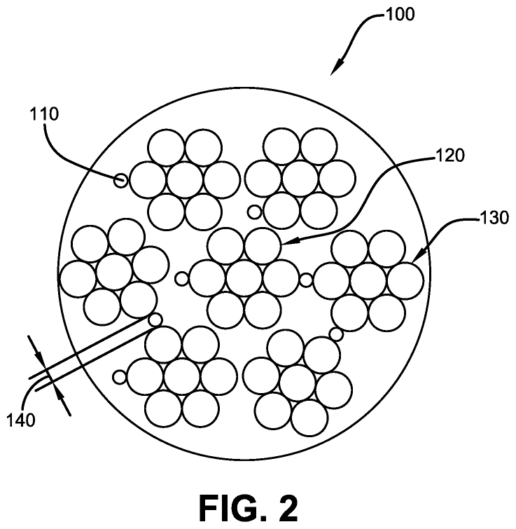

In accordance with the present invention, this gap(s) 140 may be advantageously achieved by applying a wrap or gap wire 110, consisting of a fine monofilament around the inner core strand 120 and at least 50 percent of the outer sheath strands 130, as shown in FIG. 2. The wrap wire 110 may be applied at a lay length that is less than the lay length(s) of the strands 130, 140 and may be twisted in the same or opposite direction. The wrap wire 110 may be metallic or polymeric material, such as monofilament steel and/or monofilament polyester. The wrap wire 110 may alternatively be a zinc plated steel cord or a brass plated steel cord with a zinc top coating. The diameter of the wrap wire 110 may be between 0.1 mm and 0.2 mm. The gap wire 110 may thus create a permanent and stable minimum opening/gap 140 between the steel cord strands 120, 130 to maximize the rubber penetration fully to the inner core strand 120. Once the tire is vulcanized, this gap wire 110 may provide no further structural support, and the improvement in durability from the added rubber penetration may exceed any potential deleterious effects of the gap wire 110. Increased rubber penetration may also increase the impact resistance of the cords 5, 6 as rubber between the cord strands 120, 130 may reduce stress concentrations at rubberless, empty gaps between strands 120, 130. A gap wire 110 in accordance with the present invention may also simplify wire manufacturing, eliminating addition of resins or compounds, and achieve a more robust solution where the gap 140 may be better controlled/maintained.

Variations in the present invention are possible in light of the description of it provided herein. While certain representative examples and details have been shown for the purpose of illustrating the subject invention, it will be apparent to those skilled in this art that various changes, modifications, equivalents may be made therein without departing from the scope of the subject invention. It is, therefore, to be understood that changes may be made in the particular examples described herein which will be within the fully intended scope of the present invention as defined by the following appended claims.

What is claimed:

1. A cord for reinforcing a rubber article comprising:
a core strand having a two-layer twisted layer structure formed by intertwining a plurality of filaments;
a plurality sheath strands intertwined around the core strand, the sheath strands having a twisted layer structure formed by intertwining a plurality of filaments; and
a wrap wire applied around the core strand and at least one of the sheath strands, the wrap wire creating a permanent and stable minimum gap between the core strand and the sheath strands.

2. The cord as set forth in claim 1 wherein the plurality of sheath strands includes between 4 and 8 sheath strands.

3. The cord as set forth in claim 1 wherein the core strand has a 1+6 structure with the core of the core strand comprising one core filament and six sheath filaments being intertwined around the core of the core strand to form a sheath.

4. The cord as set forth in claim 1 wherein each sheath strand has a 1+6 structure with a core of the sheath strand comprising one core filament and six sheath filaments being intertwined around the core of the sheath strand to form a sheath.

5. The cord as set forth in claim 1 wherein each filament forming the core strand has an identical diameter.

6. The cord as set forth in claim 1 wherein a diameter of the cord is 4 mm or greater.

7. The cord as set forth in claim 1 wherein a diameter of the cord is less than 5 mm.

8. The cord as set forth in claim 1 wherein the rubber article is a tire.

9. A tire comprising:
two bead structures;
a carcass extending from one bead structure to the other bead structure;
a belt disposed radially outward from the carcass;
a tread for engaging a road surface; and
a cord including a core strand having a two-layer twisted layer structure formed by intertwining a plurality of filaments, a plurality sheath strands intertwined around the core strand, the sheath strands having a twisted layer structure formed by intertwining a plurality of filaments, and a wrap wire applied around the core strand and at least one of the sheath strands, the wrap wire creating a permanent and stable minimum gap between the core strand and the sheath strands.

10. The tire as set forth in claim 9 wherein the plurality of sheath strands includes between 4 and 8 sheath strands.

11. The tire as set forth in claim 9 wherein the core strand has a 1+6 structure with the core of the core strand comprising one core filament and six sheath filaments being intertwined around the core of the core strand to form a sheath.

12. The tire as set forth in claim 9 wherein each sheath strand has a 1+6 structure with a core of the sheath strand comprising one core filament and six sheath filaments being intertwined around the core of the sheath strand to form a sheath.

13. The tire as set forth in claim 9 wherein each filament forming the core strand has an identical diameter.

14. The tire as set forth in claim 9 wherein a diameter of the cord is 4 mm or greater.

15. The tire as set forth in claim 9 wherein a diameter of the cord is less than 5 mm.

16. The tire as set forth in claim 9 wherein the wrap wire in constructed of steel.

17. The tire as set forth in claim 9 wherein the wrap wire in constructed of a polymer.

18. The tire as set forth in claim 9 wherein the wrap wire in constructed of nylon.

19. The tire as set forth in claim 9 wherein the wrap wire in constructed of polyester.

20. The tire as set forth in claim 9 wherein the wrap wire in constructed of aramid.
